(19) United States
(12) Patent Application Publication
(10) Pub. No.: US 2014/0317175 A1
(43) Pub. Date: Oct. 23, 2014

(54) TERMINAL FOR PROVIDING SOCIAL NETWORK SERVICE AND SOCIAL NETWORK SERVICE PROVIDING DEVICE

(71) Applicant: Electronics and Telecommunications Research Institute, Daejeon (KR)

(72) Inventors: Seung Chul KIM, Daejeon (KR); Sang Taick PARK, Seoul (KR); Jin Woo HONG, Daejeon (KR)

(73) Assignee: Electronics and Telecommunications Research Institute, Daejeon (KR)

(21) Appl. No.: 14/254,794

(22) Filed: Apr. 16, 2014

(30) Foreign Application Priority Data
Apr. 17, 2013 (KR) 10-2013-0042549

(51) Int. Cl. H04L 12/58; H04L 29/06

(52) U.S. Cl. CPC H04L 51/32; H04L 67/42
USPC 709/203

(57) ABSTRACT

Disclosed is a social network service providing device which interworks with a terminal through a wired/wireless network, the device. The device includes: a sign agent which provides at least one of information on the wired/wireless network and unique information of the terminal for being connected with the wired/wireless network; and a social network service client which provides at least one of the unique terminal information and unique information of a member that belongs to a group using the terminal.

This application claims the benefit of priority of Korean Patent Application No. 10-2013-0042549 filed on Apr. 17, 2013, which is incorporated by reference in its entirety herein.

### BACKGROUND OF THE INVENTION

1. Field of the Invention

The present invention relates to a terminal for providing a social network service and a social network service providing device that can provide the social network service.

2. Discussion of the Related Art

As smart terminals including a smart phone or a tablet PC are widely used, social network services are actively used and technologies associated therewith are also developed. Further, the social network services primarily serve to form a social relationship network using individuals as units and provide a resulting service.

In recent years, a TV or a settop box in a home has evolved to a smart terminal that provides an application execution function like the smart phone over a conventional broadcast receiving function and a social service experience in a portable terminal has been characterized as a primary element even in the TV.

Conventional social network services primarily provide a service such as chatting, a game, messaging, or the like with the individuals as the unit. This may be regarded as a very useful and appropriate scheme in terms of the individuals but the service by the unit of a group including the individuals cannot be provided.

### SUMMARY OF THE INVENTION

An object of the present invention is to provide a terminal that can form a group-unit social relationship network or a social network service providing device.

Another object of the present invention is to provide a social network service providing device capable of providing a social service among respective groups or among members constituting each of the groups in a community formed by a group-unit account.

Yet another objet of the present invention is to provide a social network service providing device capable of protecting privacies of the members constituting each group in the community formed by the group-unit account.

In accordance with an embodiment of the present invention, a terminal connected with a wired/wireless network may include: a sign agent which provides at least one of information on the wired/wireless network and unique information of the terminal for being connected with the wired/wireless network; and a social network service client which provides at least one of the unique terminal information and unique information of a member that belongs to a group using the terminal.

In accordance with another embodiment of the present invention, a social network service providing device which interworks with a terminal through a wired/wireless network, the device may include: a sign server which manages at least one of information on the wired/wireless network and the unique terminal information received from the terminal; and a social network service server which interworks with the sign server and manages at least one of the unique terminal information received from the terminal and unique information of a member that belongs to a group using the terminal.

The sign server may include a sign agent communication unit which receives at least one of the information on the wired/wireless network and the unique terminal information from the terminal; a first database unit which stores at least one of the information on the wired/wireless network and the unique terminal information received from the sign agent communication unit; a first control unit which processes an operation request based on at least one of the information on the wired/wireless network and the unique terminal information received from the sign agent communication unit; and a social network service server communication unit which receives the processed operation request from the first control unit to transfer the received operation request to the social network service server.

The operation request processed by the first control unit may include transferring a message “redundancy” to the social network service server communication unit when the unique terminal information received from the sign agent communication unit is present in the first database unit, and storing the unique terminal information received form the sign agent communication unit in the first database unit when the unique terminal information received from the sign agent communication unit is not present in the first database unit, and transferring at least one of the unique terminal information received form the sign agent communication unit and a message “success” to the social network service server communication unit.

The operation request processed by the first control unit may further include changing the information on the wired/wireless network that is present in the first database unit to the information on the wired/wireless network received from the sign agent communication unit and storing the changed wired/wireless network information when the unique terminal information received from the sign agent communication unit is present in the first database unit.

The social network service server may include a sign server communication unit which interworks with the social network service server communication unit and receives the processed operation request from the social network service server, and a second database unit which stores at least one of the unique terminal information and the unique information of the member received from the client communication unit.

The social network service server may further include a second control unit which receives the unique terminal information and the unique information of the member from the client communication unit to generate and register a group ID based on the unique terminal information and generate and register a member ID based on the unique information of the member, and the member ID may belong to the group ID and is generated through authentication of the terminal registered in the group ID.

The second control unit may transfer the unique terminal information received from the client communication unit to the sign server communication unit when the unique terminal information received from the client communication unit is not present in the second database unit.

The social network service server may further include a user management unit which layers and manages the group ID and the member ID and a session management unit which enables session establishment by the group ID and thereafter, session establishment by the member ID.

The social network service server may further include a community management unit which interworks with at least one of the user management unit, the session management unit, and the sign server communication unit, generates a community by an account by a plurality of group IDs, and processes a social service.

The community management unit may verify a current access state of at least one of the other group ID in the community and a member ID that belongs to the other group ID by an account of the group ID.

The community management unit may use the social service together with the other group ID in the community by the account of the group ID.

The community management unit may use the social service together with the other member ID included in the other group ID in the community by the account of the group ID.

The community management unit may use the social service together with the member ID that belongs to the other group ID by the account of the member ID included in the group ID.

The community management unit may use the social service together with the other group ID or the member ID that belongs to the other group by the account of the group ID, however, continuously use the social service by changing the member ID account included in the other group ID to the account of the member ID included in the group ID while using the social service.

The community management unit may use the social service together with the other group ID or the member ID that belongs to the other group by the account of the member ID included in the group ID, however, continuously use the social service together with the other group ID or the member ID that belongs to the other group by changing the member ID account to the group ID account while during the social service.

The community management unit may not open the social service used between the member ID and a member ID included in the other group ID.

According to the present invention, there can be provided a terminal that can form a group-unit social relationship network by a group-unit ID based on unique terminal information or a social network service providing device.

There can be provided a social service between respective groups or members constituting each group in a community formed by a group-unit account.

Privacies of the members constituting each group can be protected in the community formed by the group-unit account.

After session establishment of a group unit, session participations of the members constituting the group interwork with each other, and as a result, convenience is increased.

### BRIEF DESCRIPTION OF THE DRAWINGS

FIG. 1 is a block diagram of a terminal and a social network service providing device according to an embodiment of the present invention.

FIG. 2 illustrates a group ID and a member ID that are layered and managed.

FIG. 3 illustrates a sign server according to an embodiment of the present invention.

FIG. 4 illustrates a social network service server according to an embodiment of the present invention.

FIG. 5 illustrates a computer system according to an embodiment of the present invention.

### DETAILED DESCRIPTION OF THE EMBODIMENTS

The present invention may have various modifications and various embodiments and specific embodiments will be illustrated in the drawings and described in detail.

However, this does not limit the present invention within specific embodiments, and it should be understood that the present invention covers all the modifications, equivalents and replacements within the idea and technical scope of the present invention.

Terminologies such as first or second may be used to describe various components but the components are not limited by the above terminologies. The above terminologies are used only to discriminate one component from the other component. For example, without departing from the scope of the present invention, a first component may be referred to as a second component, and similarly, a second component may be referred to as a first component. A terminology such as and/or includes a combination of a plurality of associated items or any item of the plurality of associated items.

It should be understood that, when it is described that an element is “coupled” or “connected” to another element, the element may be “directly coupled” or “directly connected” to the another element or “coupled” or “connected” to the another element through a third element. In contrast, it should be understood that, when it is described that an element is “directly coupled” or “directly connected” to another element, it is understood that no element is not present between the element and the another element.

Terms used in the present application are used only to describe specific embodiments, and are not intended to limit the present invention. A singular form may include a plural form if there is no clearly opposite meaning in the context. In the present application, it should be understood that term “include” indicates that a feature, a number, a step, an operation, a component, a part or the combination thereof described in the specification is present, but does not exclude a possibility of presence or addition of one or more other features, numbers, steps, operations, components, parts or combinations, in advance.

If it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present invention.

Hereinafter, a preferred embodiment of the present invention will be described in more detail with reference to the accompanying drawings. In describing the present invention, like reference numerals refer to like elements for easy overall understanding and a duplicated description of like elements will be omitted.

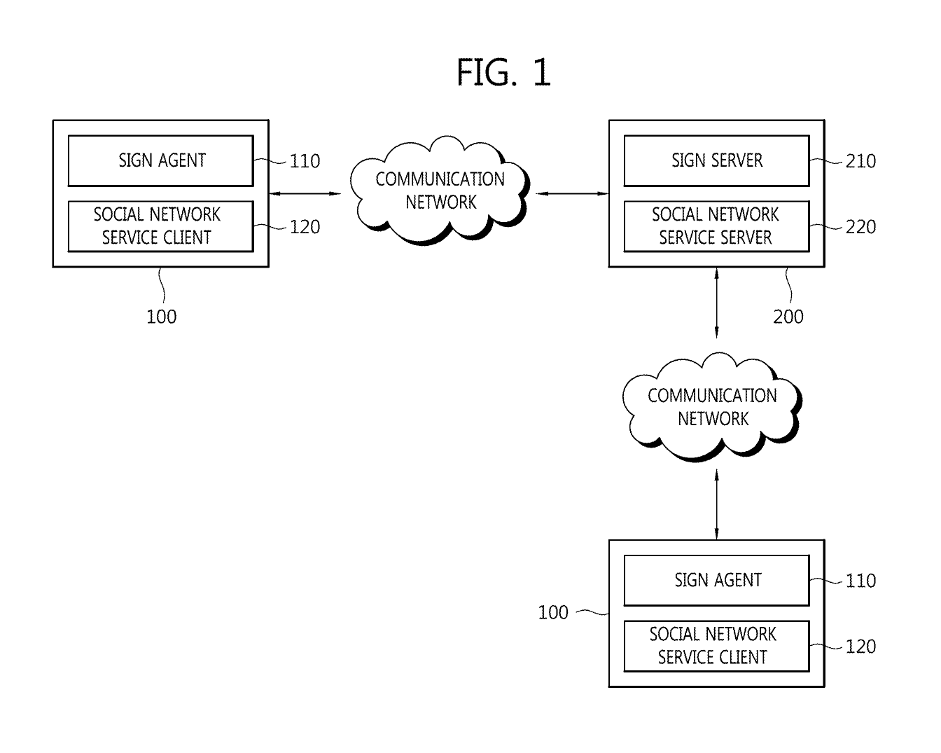

FIG. 1 illustrates a terminal 100 for providing a social network service and a social network service providing device 200 according to an embodiment of the present invention.

Referring to FIG. 1, the terminal 100 for providing the social network service according to the present invention may be connected with a wired/wireless network and include a sign agent 110 and a social network service client 120.

The sign agent 110 according to the embodiment of the present invention provides at least one of information on the wired/wireless network and unique information of the terminal for connection with the wired/wireless network. The information on the wired/wireless network includes information required for the terminal 100 to access the wired/wireless network when a social network service function is activated and the unique terminal information may include a serial number of the terminal 100 and a phone number of the terminal 100. The information on the wired/wireless network and/or the unique terminal information may be transmitted to a sign server 210 included in the social network service providing device 200 to be described below.

The social network service client 120 according to the embodiment of the present invention may provide one of the unique terminal information and unique information of a member that belongs to a group using the terminal 100 to a social network service server 200 to be described below. The unique information of the member may include a name, a phone number, an age, an occupation, a family relationship, a resident registration number, and the like. A member information input interface may be displayed in the social network service client 120 according to the embodiment of the present invention in order to receive the unique information of the member. Alternatively, a service interface required to social services including registration and deregistration of an ID including a member ID and a group ID, a chatting window, messaging alarm and display, invitation of a chatting partner, and the like may be displayed in the social network service client 120 according to the embodiment of the present invention.

The group according to the embodiment of the present invention may include a family, a club, an organization, or a corporate and the member may be a family member, a club member, an organization member, and a corporate staff and employee constituting the group.

The terminal 100 according to the embodiment of the present invention may include an IPTV, a PDP, a tablet PC, a settop box, a smart phone, and the like.

Referring back to FIG. 1, the social network service providing device 200 according to the embodiment of the present invention may interwork with the terminal 100 through the wired/wireless network and include the sign server 210 and the social network service server 220.

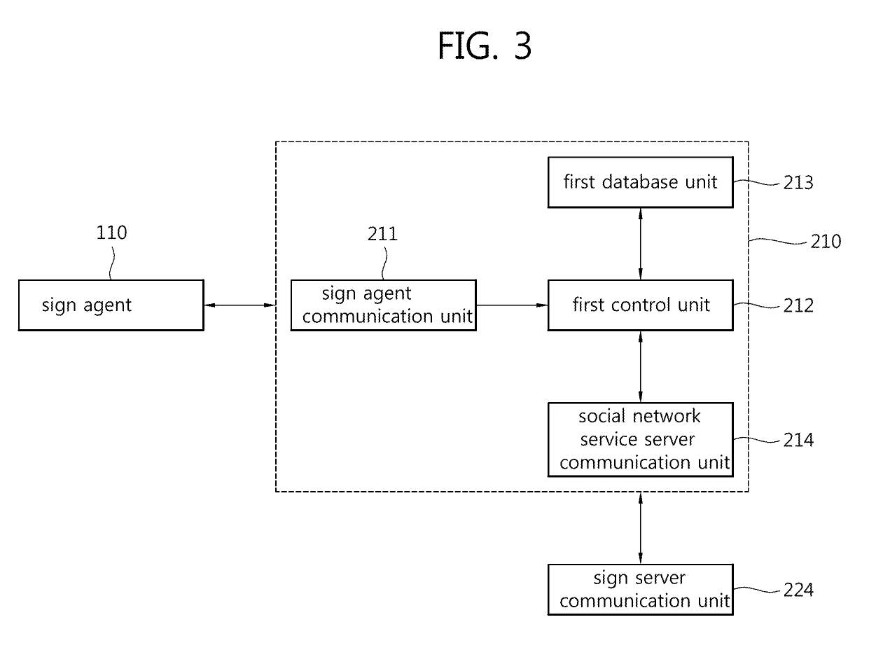

Referring to FIG. 3, the sign server 210 according to the embodiment of the present invention may manage at least one of the information on the wired/wireless network and the unique terminal information received from the terminal 100. The sign server 210 according to the embodiment of the present invention may include a sign agent communication unit 211, a first control unit 212, a first database unit 213, and a social network service server communication unit 214.

The sign agent communication unit 211 according to the embodiment of the present invention may receive at least one of the information on the wired/wireless network and the unique terminal information from the terminal 100.

The sign agent communication unit 211 according to the embodiment of the present invention is connected with the sign agent 110 included in the terminal 100 through the wired/wireless communication network and receives the information on the wired/wireless network and/or the unique terminal information from the sign agent 110 to transfer the received wired/wireless network information and/or unique terminal information to the first control unit 212 and the first database unit 213.

The first database unit 213 according to the embodiment of the present invention may store the information on the wired/wireless network and/or unique terminal information received from the sign agent communication unit 211.

The first control unit 212 according to the embodiment of the present invention may process an operation request based on at least one of the information on the wired/wireless network and/or the unique terminal information received from the sign agent communication unit 211. The operation request processed herein may include transferring a message “redundancy” to the social network service server communication unit 214 when the unique terminal information received from the sign agent communication unit 211 is present in the first database unit 213, storing the unique terminal information received form the sign agent communication unit 211 in the first database unit 213 when the unique terminal information received from the sign agent communication unit 211 is not present in the first database unit 213, and transferring at least one of the unique terminal information received form the sign agent communication unit 211 and a message “success” to the social network service server communication unit 214. Alternatively, the operation request processed by the first control unit 212 may further include changing the information on the wired/wireless network that is present in the first database unit 213 to the information on the wired/wireless network received from the sign agent communication unit 211 and storing the changed wired/wireless network information when the unique terminal information received from the sign agent communication unit 211 is present in the first database unit 213.

The social network service server communication unit 214 according to the embodiment of the present invention receives the operation request processed from the first control unit 212 to transfer the received operation request to the social network service server 220. Alternatively, the social network service server communication unit 214 according to the embodiment of the present invention receives the operation request processed from the first control unit 212 to transfer the received operation request to the sign server communication unit 224 included in the social network service server 220.

The social network service server 220 according to the embodiment of the present invention may interwork with the sign server 210 and manage at least one of the unique terminal information received from the terminal 100 and unique information of a member that belongs to a group using the terminal 100. The social network service server 220 according to the embodiment of the present invention may interwork with the social network service client 120 of the terminal 100 and receive at least one of the unique terminal information and the unique information of the member that belongs to the group using the terminal 100.

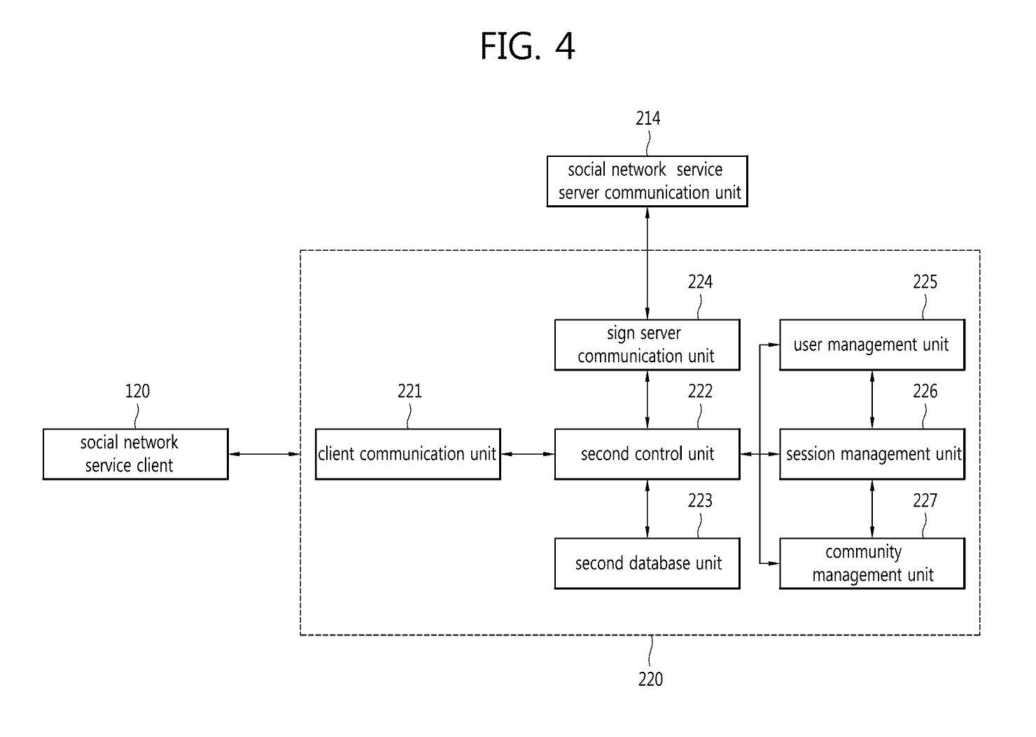

Referring to FIG. 4, the social network service server 220 according to the embodiment of the present invention may include a client communication unit 221, a sign server communication unit 224, and a second database unit 223.

The client communication unit 211 according to the embodiment of the present invention may receive at least one of the unique terminal information and the unique information of the member from the terminal 100. Alternatively, the client communication unit 221 may interwork with the social network service client 120 included in the terminal 100 and receive at least one of the unique terminal information and the unique information of the member that belongs to the group using the terminal 100 from the social network service client 120.

The sign server communication unit 224 according to the embodiment of the present invention may interwork with the social network service server communication unit 214 and receive the operation request processed by the first control unit 212 from the social network service server 220.

The second database unit 223 according to the embodiment of the present invention may store at least one of the unique terminal information and the unique information of the member received from the client communication unit 221.

The social network service server 220 according to the embodiment of the present invention may further include a second control unit 222. The second control unit 222 according to the embodiment of the present invention may receive at least one of the unique terminal information and the unique information of the member from the client communication unit 221, generate a group ID based on the unique terminal information, and generate the member ID based on the unique information of the member. The member ID generated by the second control unit 222 may belong to the group ID and be generated through authentication of the terminal 100 registered in the group ID.

Since the group ID is generated based on the unique terminal information, one group ID may be generated for each terminal 100 and one or more member IDs may be generated for each group ID based on unique information of members that share the group ID.

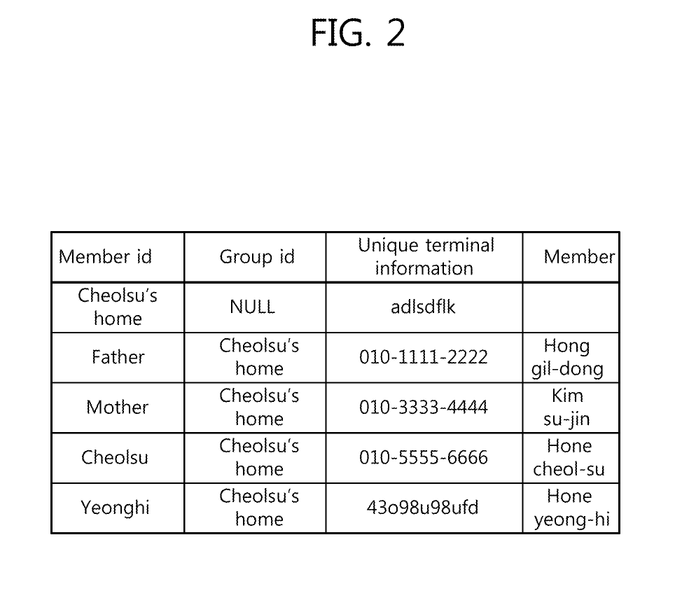

Referring to FIG. 2, the group ID may be Cheolsu's home and the member ID may be father, mother, Cheolsu, or Yeonghi. Father, mother, Cheolsu, or Yeonghi which is the member ID may be generated through authentication of the terminal 100 registered in the group ID. For example, when the group is the family, the group ID may be generated based on a serial number of a settop box and the member ID may be generated based on unique information of family members that may share the settop box. In this case, the member ID may be generated in the settop box through the authentication.

Accordingly, according to the embodiment of the present invention, since a social relationship network of a group unit such as the family may be formed through the group ID and a separate member ID may be separately formed for each of the members constituting the group, a social service may be transmitted between the members, between the member and the group, or between the groups. Herein, the social service may include an SMS message, chatting, an alarm, and the like.

The second control unit 222 according to the embodiment of the present invention may transfer the unique terminal information received from the client communication unit 221 to the sign server communication unit 224 when the unique information of the member received from the client communication unit 221 is not present in the second database unit 223. When the unique terminal information transferred to the sign server communication unit 224 is not present in the first database unit 213, the unique terminal information received from the sign server communication unit 224 may be stored in the first database unit 213 and at least one of the unique terminal information received from the sign agent communication unit 211 and the message “success” may be transferred to the social network service server communication unit 214 again.

The social network service server 220 according to the embodiment of the present invention may further include a user management unit 225 and a session management unit 226.

The user management unit 225 according to the embodiment of the present invention may layer and manage the group ID and the member ID. Referring to FIG. 2, the user management unit 225 according to the embodiment of the present invention may layer and include the member ID such as “father, mother, Cheolsu, or Yeonghi” in the group ID such as “Cheolsu's home.

The session management unit 226 according to the embodiment of the present invention may enable session establishment by the group ID and thereafter, session establishment by the member ID. For example, the session management unit 226 may access the group ID such as “Cheolsu's home” and access the member ID such as “Cheolsu” while the accessed group ID is maintained.

Alternatively, when the session management unit 226 according to the embodiment of the present invention intends to communicate with the other group ID by accessing the group ID, the session management unit 226 may verify member IDs that belong to the other group ID through the user management unit 225 and simultaneously send a session joining request to member IDs in which a social network service of a current terminal 100 is activated for communication with the sign server 210. Herein, the other group IDs may be one or more and the member ID may include member IDs that belong to one or more respective other group IDs.

The social network service server 220 according to the embodiment of the present invention may further include a community management unit 227. The community management unit 227 according to the embodiment of the present invention may be interworked with at least one of the user management unit 225, the session management unit 226, and the sign server communication unit 224. The community management unit 227 according to the embodiment of the present invention may generate a community by an account by a plurality of group IDs so as to form a group-unit social relationship network.

The community management unit 227 according to the embodiment of the present invention may verify a current access state of at least one of the other group ID in the community and a member ID that belongs to the other group ID by an account of the group ID. The community management unit 227 according to the embodiment of the present invention is connected with the user management unit 225, and receives the other group ID managed by the user management unit 225 and the member IDs that belong to the other group ID to verify all of the other group IDs in the community and the member IDs that belong to the other group ID. The community management unit 227 may receive current access states of the verified other group ID and/or the verified member ID.

The community management unit 227 according to the embodiment of the present invention may use the social service by the account of the group ID together with the other group ID in the community. In this case, a content of the social service used between the group IDs may be opened to the member ID included in each group ID. Accordingly, the community management unit 227 according to the embodiment of the present invention may form the group-unit social relationship network and use a group-to-group social service within the group-unit social relationship network.

The community management unit 227 according to the embodiment of the present invention may use the social service together with the other member ID included in the other group ID in the community by the account of the group ID. Accordingly, according to the embodiment of the present invention, the social service may be provided between the group and the member that belongs to each group within the group-unit social relationship network.

The community management unit 227 according to the embodiment of the present invention may use the social service together with the member ID that belongs to the other group ID by the account of the member ID included in the group ID after the session establishment with the group ID by the account of the group ID. For example, when two families join in a network game which multiple persons may participate in, there is an inconvenience that members of each family need to individually access the corresponding game in a known person unit social network service. However, according to the embodiment of the present invention, session participation among the members of each group may be interworked after the session establishment of the groups.

The community management unit 227 according to the embodiment of the present invention may use the social service together with the other group ID or the member ID that belongs to the other group by the account of the group ID, and changes the account of the other group ID to the account of the member ID that belongs to the group ID while using the social service to continuously use the social service together with the other group ID or the member ID that belongs to the other group. For example, under an environment using an IPTV as the terminal 100, chatting with the other group ID and/or the member ID that belongs to the other group ID may be enabled by the account of the member ID that belongs to the group ID while sharing a chatting content with the member IDs that belong to the other group ID by the account of the group ID. In this case, the chatting content between the member IDs are not opened to the outside to protect a privacy of the member. Alternatively, under the environment using the IPTV as the terminal 100, chatting with the other group ID and/or the member ID that belongs to the other group ID may be enabled with the personal terminal 100 of the member by changing the group ID account to the member account that belongs to the group ID while maintaining the group ID account while sharing a chatting content with the member IDs that belong to the other group ID by the account of the group ID. Also, even in this case, the chatting content between the member IDs are not opened to the outside to protect a privacy of the member.

The community management unit 227 according to the embodiment of the present invention may use the social service together with the other group ID by the account of the group ID and the member ID that belongs to the other group ID by the account of the member ID included in the group ID after the session establishment. The member ID account is changed to the group ID account while using the social service together with the other group ID or the other member ID by the member ID account to continuously use the social service together with the other group ID or the other member ID.

The social service according to the embodiment of the present invention may include chatting, an alarm, a short message service (SMS), a multimedia messaging service (MMS), a game, a moving picture, a photograph, and the like.

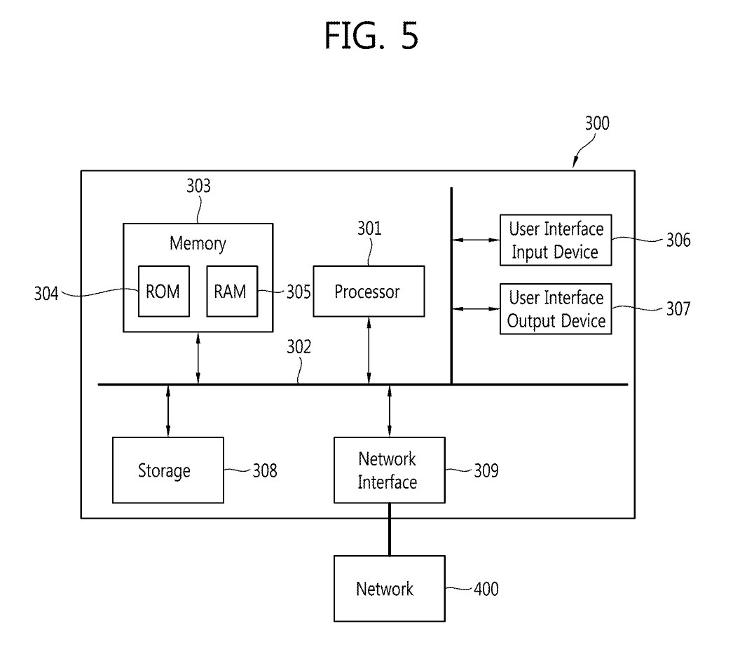

An embodiment of the present invention may be implemented in a computer system, e.g., as a computer readable medium. As shown in FIG. 5, a computer system 300 may include one or more of a processor 301, a memory 303, a user input device 306, a user output device 307, and a storage 308, each of which communicates through a bus 302. The computer system 300 may also include a network interface 309 that is coupled to a network 400. The processor 301 may be a central processing unit (CPU) or a semiconductor device that executes processing instructions stored in the memory 303 and/or the storage 308. The memory 303 and the storage 308 may include various forms of volatile or non-volatile storage media. For example, the memory may include a read-only memory (ROM) 304 and a random access memory (RAM) 305.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

What is claimed is:

1. A terminal connected with a wired/wireless network, comprising:
a sign agent which provides at least one of information on the wired/wireless network and unique information of the terminal for being connected with the wired/wireless network; and
a social network service client which provides at least one of the unique terminal information and unique information of a member that belongs to a group using the terminal.

2. A social network service providing device which interworks with a terminal through a wired/wireless network, the device comprising:
a sign server which manages at least one of the information on wired/wireless network and unique terminal information received from the terminal; and
a social network service server which interworks with the sign server and manages at least one of the unique terminal information received from the terminal and unique information of a member that belongs to a group using the terminal.

3. The device of claim 2, wherein:
the sign server includes,
a sign agent communication unit which receives at least one of the information on the wired/wireless network and the unique terminal information from the terminal;
a first database unit which stores at least one of the information on the wired/wireless network and the unique terminal information received from the sign agent communication unit;
a first control unit which processes an operation request based on at least one of the information on the wired/wireless network and the unique terminal information received from the sign agent communication unit; and
a social network service server communication unit which receives the processed operation request from the first control unit to transfer the received operation request to the social network service server.

4. The device of claim 3, wherein:
the operation request processed by the first control unit includes,
transferring a message “redundancy” to the social network service server communication unit when the unique terminal information received from the sign agent communication unit is present in the first database unit, and
storing the unique terminal information received form the sign agent communication unit in the first database unit when the unique terminal information received from the sign agent communication unit is not present in the first database unit, and transferring at least one of the unique terminal information received form the sign agent communication unit and a message “success” to the social network service server communication unit.

5. The device of claim 3, wherein:
the operation request processed by the first control unit further includes,
changing the information on the wired/wireless network that is present in the first database unit to the information on the wired/wireless network received from the sign agent communication unit and storing the changed wired/wireless network information when the unique terminal information received from the sign agent communication unit is present in the first database unit.

6. The device of claim 2, wherein:
the social network service server includes,
a client communication unit which receives at least one of the unique terminal information and the unique information of the member from the terminal,
a sign server communication unit which interworks with the social network service server communication unit and receives the processed operation request from the social network service server, and
a second database unit which stores at least one of the unique terminal information and the unique information of the member received from the client communication unit.

7. The device of claim 6, wherein:
the social network service server further includes,
a second control unit which receives the unique terminal information and the unique information of the member from the client communication unit to generate and register a group ID based on the unique terminal information and generate and register a member ID based on the unique information of the member, and
the member ID belongs to the group ID and is generated through authentication of the terminal registered in the group ID.

8. The device of claim 7, wherein the second control unit transfers the unique terminal information received from the client communication unit to the sign server communication unit when the unique terminal information received from the client communication unit is not present in the second database unit.

9. The device of claim 7, wherein the social network service server further includes a user management unit which layers and manages the group ID and the member ID and a session management unit which enables session establishment by the group ID and thereafter, session establishment by the member ID.

10. The device of claim 7, wherein the social network service server further includes a community management unit which interworks with at least one of the user management unit, the session management unit, and the sign server communication unit, generates a community by an account by a plurality of group IDs, and processes a social service.

11. The device of claim 10, wherein the community management unit verifies a current access state of at least one of the other group ID in the community and a member ID that belongs to the other group ID by an account of the group ID.

12. The device of claim 10, wherein the community management unit uses the social service together with the other group ID in the community by the account of the group ID.

13. The device of claim 10, wherein the community management unit uses the social service together with the other member ID included in the other group ID in the community by the account of the group ID.

14. The device of claim 10, wherein the community management unit uses the social service together with the member ID that belongs to the other group ID by the account of the member ID included in the group ID.

15. The device of claim 10, wherein the community management unit uses the social service together with the other group ID or the member ID that belongs to the other group by the account of the group ID, and changes the account of the other group ID to the account of the member ID included in the group ID while using the social service to continuously use the social service together with the other group ID or the member ID that belongs to the other group

16. The device of claim 10, wherein the community management unit uses the social service together with the other group ID or the member ID that belongs to the other group by the account of the member ID included in the group ID, however, continuously uses the social service together with the other group ID or the member ID that belongs to the other group by changing the member ID account to the group ID account while during the social service.

17. The device of claim 14, wherein the community management unit does not open the social service used between the member ID and a member ID included in the other group ID.

18. The device of claim 15, wherein the community management unit does not open the social service used between the member ID and a member ID included in the other group ID.

19. The device of claim 16, wherein the community management unit does not open the social service used between the member ID and a member ID included in the other group ID.
